(19) United States
(12) Patent Application Publication
(10) Pub. No.: US 2003/0001547 A1
(43) Pub. Date: Jan. 2, 2003

(54) Switching regulator and amplifier utilizing said regulator

(76) Inventor: Dieter Jurzitza, Karlsruhe (DE)

Correspondence Address: Samuels, Gauthier & Stevens LLP, Suite 3300, 225 Franklin Street, Boston, MA, 02110, US

(21) Appl. No.: 10/158,402

(22) Filed: May 30, 2002

(30) Foreign Application Priority Data
May 30, 2001 (DE) 101 26 236.1

(51) Int. Cl. G05F 1/613

(52) U.S. Cl. 323/225

(57) ABSTRACT

A switching regulator includes a supply voltage terminal (IN), a ground terminal (OUT), a ground terminal (OUT), an inductive element (L) in which a first terminal is connectable through a first switch (T1) to a supply voltage terminal (IN), a capacitive element (C) in which a first terminal is connected to a second terminal of the inductive element (L) and a second terminal to the ground terminal (GND), and an output terminal (OUT) for outputting an output voltage, which terminal is connected to the first terminal of the capacitive element (C). A second switch (T4) is arranged in parallel with the capacitive element (C). The switching regulator is suited for constructing an amplifier for an audio signal.

The invention relates to a switching regulator and its utilization in an amplifier, specifically an amplifier for audio signals.

Various types of switching regulators are known, the circuits of which differ depending on whether they are intended to supply an output voltage with a supply voltage of the opposite sign, an output voltage between 0 and the supply voltage, or an output voltage above the supply voltage. All of these switching regulators have an LC element composed of an inductive element and a capacitive element, and at least one switch that, by alternately opening and closing, allows for the storage in the LC element of electrical energy supplied through the supply voltage terminal and for the output of the stored energy on another voltage level at the output terminal. The basic principles of such switching regulators are described in Tietze-Schenck, Halbleiterschaltungstechnik [Semiconductor Switching Technology] 11^{th} edition, Springer-Verlag, Berlin, 1999, pages 979 et seq.

A disadvantage of these known switching regulators is that they are usable only within a limited output voltage range. In order to construct a switching regulator which can supply output voltages above and below a given supply voltage, two of these known switching regulators must be provided in parallel—one of the type known as a step-up controller or step-up converter and one of the type known as a step-down controller or step-down converter—and operated alternately depending on the output voltage required. Not only does this approach require a high level of circuit complexity for the switching regulators themselves, but their control is complicated since different switches following different principles of interaction between switch duty cycle and generated output voltage must be controlled according to whether the output voltages to be supplied are above or below the supply voltage.

One goal of the invention is to provide a switching regulator which uses a simple control which does not require any case-by-case discrimination between output voltages above and below the supply voltage and generates output voltages in a range on both sides of the level of the supply voltage.

According to the invention, this goal is achieved by a switching regulator including a supply voltage terminal, a ground terminal, an inductive element in which a first terminal is connectable through a first switch to the supply voltage, a capacitive element in which a first terminal is connected to a second terminal of the inductive element and a second terminal to the ground terminal, and an output terminal for outputting an output voltage, which terminal is connected to the first terminal of the capacitive element, the switching regulator being characterized in that a second switch is arranged in parallel to the capacitive element.

In a first phase of switching regulator operation in which two switches are closed, this circuit enables a current to bypass the capacitive element and to be conducted from the supply voltage terminal through the inductive element directly to ground so as to store an energy proportional to the square of the instantaneous current in the inductive element in this element, while in a second phase of operation in which the switches are closed the circuit allows the energy stored in the inductive element to be smoothed and output through the capacitive element at the output terminal.

Preferably, in a certain switching position of the switch a diode is arranged with reverse bias in terms of the supply voltage in parallel to the series circuit of the inductive and capacitive elements. This diode blocks as long as the switches are opened but becomes conductive for the current generated by the inductive element when the switches are closed.

The in-phase opening and closing of the two switches generates simply as a function of the common duty cycle of the two switches an output voltage which can assume values between 0 and a given limiting value which lies above the supply voltage.

In the event an output voltage significantly above the supply voltage at high output power is required, there is the additional possibility of keeping the first switch continuously open, instead of the in-phase control of the two switches, and only opening and closing the second switch at a given duty cycle. In this type of control, the current flow from the supply voltage terminal to the inductive element is never interrupted so that on average a greater current is allowed to flow in the inductive element than during alternate operation of the two switches. This greater current corresponds to a greater amount of energy stored in the inductive element and thus a greater output power available at the output terminal at a given output voltage. Although this complicates the control circuitry, the complication is acceptable in view of the improved output power.

In the event an output voltage significantly below the supply voltage at high output power is required, there is the additional possibility of keeping the second switch continuously open, instead of the in-phase control of the two switches, and only opening and closing the first one at a given duty cycle. In this type of control, any drain of the current flowing through the inductive element via the second switch to ground is blocked and the entire current flow from the supply voltage terminal is forced through the load RLOAD.

A control circuit to drive the switches of the switching regulator is preferably contained in this switching regulator.

Preferably, the switching regulator also includes a fourth switch to interrupt the connection between the second terminal of the inductive element and the first terminal of the capacitive element, as well as a second diode which, with reverse bias with respect to the supply voltage, connects the first terminals of the inductive element and the capacitive element. As long as this fourth switch remains closed, the switching regulator supplies an output voltage with the sign of the supply voltage. However, if the fourth switch remains open, the alternate opening and closing of the first switch causes the switching regulator to operate as an inverter.

A fifth switch is appropriately arranged in series with the second diode between the first terminals of the inductive element and the capacitive element. This switch is kept open during operation of the switching regulator to generate an output voltage with the sign of the supply voltage to prevent the output current supplied by the inductive element from flowing through the second diode instead of through the load R_{LOAD}. During inverter operation, the fifth switch is open.

A preferred application of the switching regulator according to the invention is an amplifier, specifically an amplifier for a low-frequency signal such as an audio signal in which the output voltage of the switching regulator is regulated as a function of the instantaneous value of the audio signal, and the output signal of the amplifier is derived from the output voltage of the switching regulator.

This type of amplifier is appropriately provided with a comparator for comparing the output voltage of the switching regulator with a voltage specified as a function of the amplifier input signal. This type of comparator provides for the generation of an output voltage with a high degree of linearity.

In order to suppress the residual ripple in the amplified signal normally contained in the output voltage of the switching regulator as a result of its switch-mode operation, a low-pass filter is appropriately located between the output terminal of the switching regulator and the output of the amplifier. The cutoff frequency of this filter is between the upper cutoff frequency of the signal to be amplified and the keying rate at which the switches are switched on and off.

Additional characteristic features and advantages of the invention are disclosed in the following description of embodiments which reference to the attached figures.

FIG. 1 is a simple embodiment of a switching regulator according to the invention for generating output voltages both above and below the supply voltage.

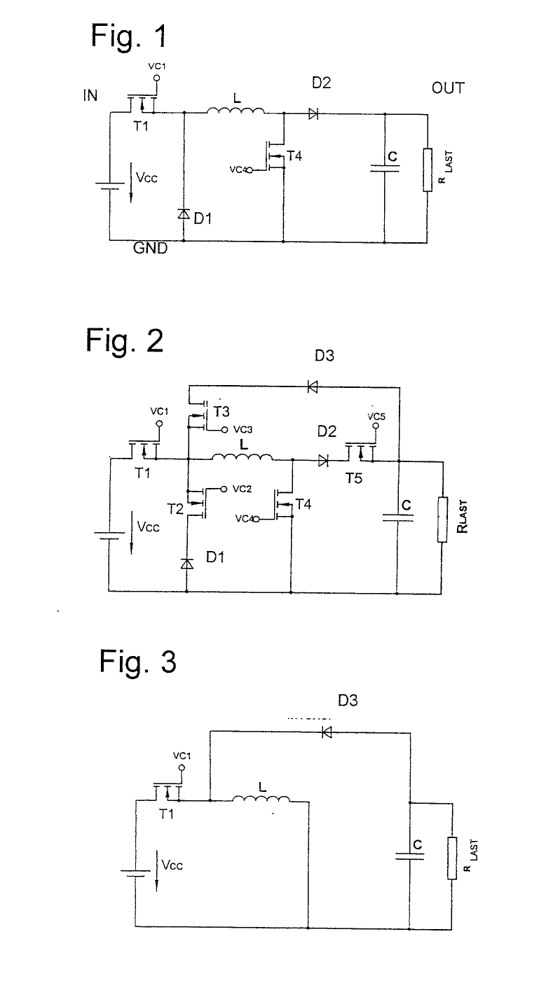

FIG. 2 is a modification of the switching regulator in FIG. 1 which is able supply bipolar output voltages.

FIG. 3 is a simplified diagram of the switching regulator in FIG. 2 in which only those switching components are shown which are involved in the inverter operation of the switching regulator.

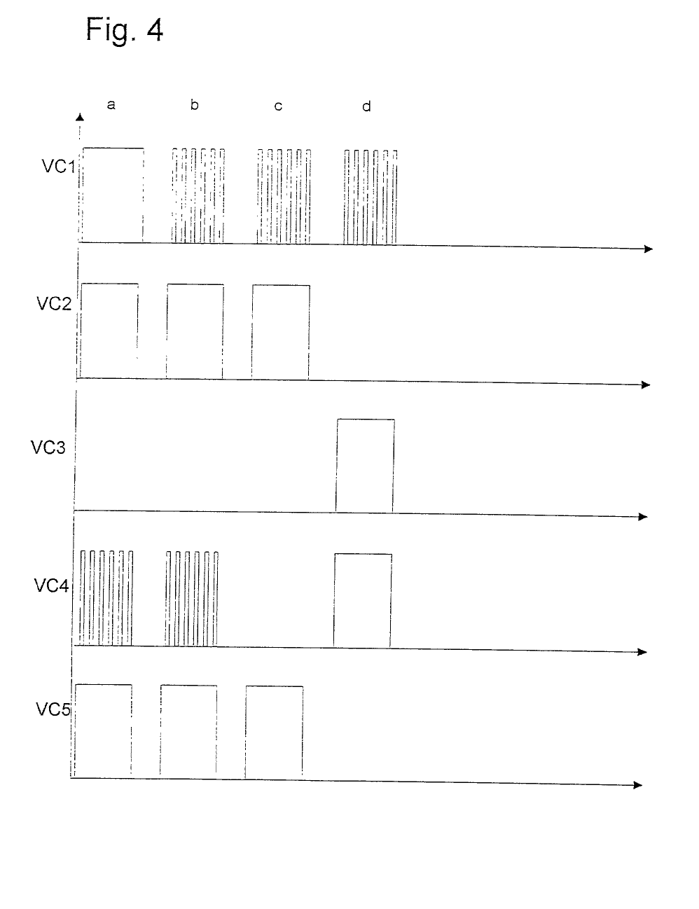

FIG. 4 is the characteristic over time of the control signals of the various switches during operation of the switching regulator in FIG. 2 as a step-up converter, step-down converter, in an intermediary operational state, and as an inverter.

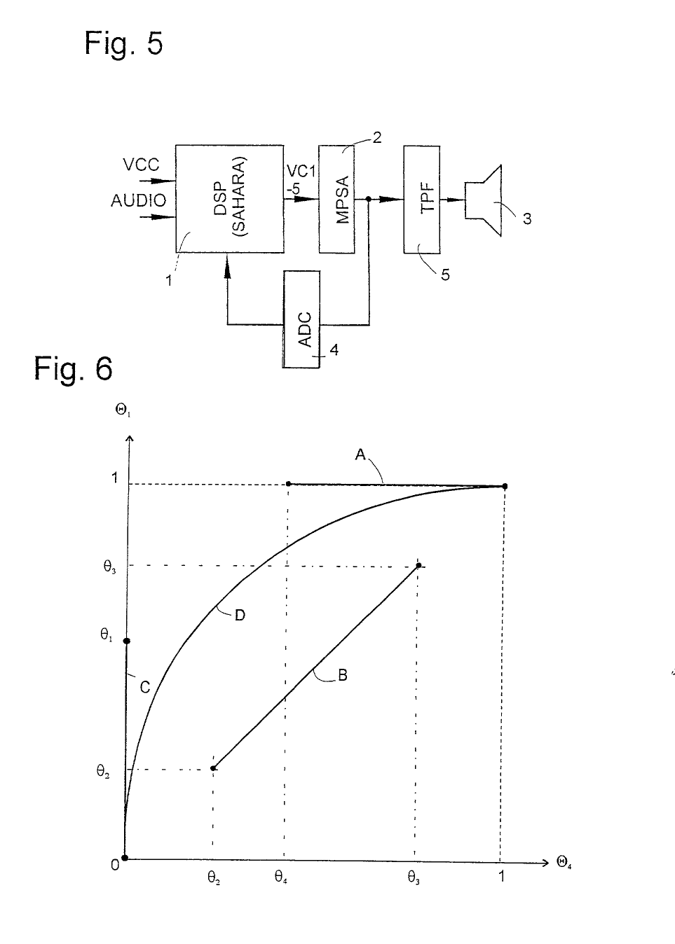

FIG. 5 is a block diagram of an audio amplifier system which employs the switching regulator according to the invention.

FIG. 6 presents variants in the control of the transistors in the circuit of FIG. 1 or FIG. 2.

FIG. 1 is a schematic block diagram of a first simple embodiment of the switching regulator according to the invention. A first switch in the form of a field-effect transistor T1 is located between a supply voltage terminal IN and a first terminal of an inductor L. The switch is supplied by a control device (not shown) with a control voltage VC1. A first diode D1 is connected both to the first terminal of inductor L and to a ground terminal GND oriented such that it blocks the supply current flowing through switch T1.

A second terminal of inductor L is connected through a second diode D2 oriented in the direction of flow to the first terminal of a capacitor C, the second terminal of which is also applied to ground terminal GND. A second switch T4 supplied by the control circuit with a control voltage VC4 is located between the second terminal of inductor L and the ground terminal.

A load resistance R_{LOAD} located between the output terminal OUT and the ground represents a load which is supplied by the switching regulator.

The two field-effect transistors T1, T4 are each switched on and off in phase by the control circuit by means of control voltages VC1, VC4. When both transistors are simultaneously conductive, a current flow builds up from the supply voltage terminal IN through transistor T1, inductor L, and transistor T4 to ground. When both transistors T1, T4 are simultaneously connected at high resistance, a quantity of energy 0.5×L×I² is stored in inductor L, where L is the inductance of the inductor and I the current in the inductor at the instant of the high-resistance connection of the transistors. The result of this quantity of energy is that a non-negligible voltage is built up at the second terminal of inductor L which flows through diode D2 and then, smoothed, through capacitor C via load R_{LOAD} to ground.

In the limiting case in which the duty cycles of both transistors T1, T4 go to 0, the voltage at output terminal OUT may assume any values close to 0.

To illustrate the performance of the circuit in the limiting case in which both duty cycles go to 1, the case may be considered in which the duty cycle of transistor T1 is exactly 1 while that of transistor T4 is 1-ε, where ε is a low real number. In this case, the circuit of FIG. 1 responds like a conventional step-up converter with a duty cycle of 1-ε, this converter supplying an output voltage which is significantly above the supply voltage. As is evident, simply by varying the duty cycles of transistors T1, T4 which are the same with respect to each other but jointly variable by the control circuit, the circuit of FIG. 1 is able to generate output voltages in the range between 0 and an upper cutoff value determined by the intrinsic resistances of the circuit elements.

FIG. 2 shows a modification of the switching regulator of FIG. 1 which has been augmented by a series of additional circuit components. Those components already present in the circuit of FIG. 1 have the same reference identification and will not be described again. Among the additional components are: a field-effect transistor T2 connected in series with diode D1 between the first terminal of inductor L and ground, a field-effect transistor T5 connected in series with diode D2 between the second terminal of inductor L and the first terminal of capacitor C, and a series circuit comprising a field-effect transistor T3 and a diode D3 which connects the first terminal of inductor L1 to the first terminal of capacitor C.

FIG. 4 shows the characteristic over time of control voltages VC1 through VC5 which are fed to transistors T1 through T5 as a function of a given output voltage to be generated.

In a first operating mode of the circuit of FIG. 2, shown as column a in FIG. 4, transistors T1, T2, T5 are connected at low resistance by control voltages VC1, VC2, VC5, transistor T3 is at high resistance, and transistor T4 is operated in alternating mode. This pattern for controlling the transistors reflects operation of the switching regulator purely as a step-up converter which is able to supply voltages, depending on the duty cycle at which transistor T4 is switched, between the supply voltage VCC and an upper voltage limit.

In the mode of column b, transistors T1, T4 are operated on an alternating basis, while transistors T2, T5 are at low resistance and T3 blocks. This operating mode matches that described above for FIG. 1.

In a third mode, shown as column c, transistor T1 is operated in alternating mode, transistors T2 and T5 are at low resistance, and transistor T3 and T4 are at high resistance. This reflects operation of the circuit as a step-down converter which is able to supply output voltages between 0 and the supply voltage.

In a fourth mode, column d of FIG. 4, transistor T1 is operated in alternating mode, transistors T3, T4 are at low resistance, and transistors T2, T5 are at high resistance.

FIG. 3 is a simplified view of the circuit of FIG. 2 in which all connections in this fourth mode containing a high-resistance transistor are omitted and the permanently low-resistance transistor T4 is replaced by a straight line. When transistor T1 is open in this circuit, a current is built up through inductor L which, upon closing of transistor T1, results in a voltage drop to negative values at the first terminal of inductor L1 connected to transistor T1. This voltage drop is passed on through the now conductive diode D3 to output terminal OUT. This means that in the mode of column d the circuit acts as an inverter.

Depending on the control of the various transistors, the circuit of FIG. 2 is thus able to generate both positive as well as negative output voltages, the values of which can exceed that of the supply voltage.

FIG. 4 differentiates between three different operating modes for the switching regulator shown in columns a, b, c generating an output voltage of the same sign as the supply voltage. These modes are illustrated in the diagram of FIG. 6 which shows combinations of duty cycles Θ₁,Θ₄ of the two transistors T1, T4 as straight-line sections A, B, C. When these three modes are used to generate an output voltage which increases continuously from zero, the duty cycle of the first switch is raised from 0 to a value Θ₁ in the mode of column a with second transistor T4 closed, at which value the first limit of the output voltage below the output voltage is reached (straight-line section C), then the system changes to the mode of column b in which both switches T1, T4 are operated at a duty cycle which rises from an initial value Θ₂, corresponding to the first limit, to a final value Θ₃ which corresponds to a second limit for the voltage above the supply voltage (straight-line section B); finally, the system changes to the mode of column a in which first transistor T1 remains continuously open and the duty cycle of the second transistor is increased from an initial value Θ₄ to approximately 1 (straight-line section A). Alternatively, duty cycles Θ₁, Θ₄ which differ from 0, 1 or identity are also permissible; in this way, a desired characteristic for the output voltage may be reproduced, for example, by following the continuous trajectory D.

The circuit of FIG. 2 is suited for constructing an audio amplifier with which even high-impedance loudspeakers having a significant output power may be driven. FIG. 5 shows a block diagram of this type of audio amplifier. It includes a digital signal processor (DSP) to which a supply voltage VCC and an audio signal AUDIO are fed. The audio signal may be digital from the outset, or digitized in an A/D converter (not shown) for processing in the digital signal processor 1. Based on each digital audio signal value, signal processor 1 calculates an output voltage for the switching regulator 2 according to the invention required to drive a loudspeaker 3 and applies the corresponding control voltages VC1 through VC5 to the transistors of the controller. These control voltages or duty cycles for the transistors alternately operated in the different modes may be determined from tables stored in the control circuit which specify these parameters as a function of the required output voltage. Loudspeaker 3 is connected to the output of switching regulator 2 through a low-pass filter 5.

An analog-to-digital converter 4 is coupled to the output terminal of switching regulator 2 in order to return a digitized value for the output voltage to digital signal processor 1. This processor compares the value provided by analog-to-digital converter 4 with the previously calculated desired output value and, in the event of a deviation, corrects the duty cycle of the transistors operated alternately in the currently used mode a, b, c, or d.

It is evident that the keying rate at which signal processor 1 controls switching regulator 2 must lie by a multiple factor above the upper cutoff frequency of the audio signal in order to ensure that the residual ripple at the output of the switching regulator attributable to the alternate switching of the transistors can be effectively suppressed by low-pass filter 5.

If the applied audio signal AUDIO is a digital signal, it is appropriate to select an operating frequency for analog-to-digital converter 4 which is equal to the sampling frequency of the audio signal or a small multiple of it, for example, 44.1 kHz. To preclude distortions in the output signal of the amplifier caused by the time-discrete functioning of the switching regulator, the frequency of the sampling values must be larger by a multiple factor than the operating frequency of the switching regulator. This means that given an assumed pulse keying rate of 44.1 kHz and a ratio of frequencies on the order of 10, low-distortion amplification of the audio signals is possible in a frequency range up to approximately 4 kHz.

1. Switching regulator including a supply voltage terminal (IN), a ground terminal (OUT), an inductive element (L) in which a first terminal is connectable through a first switch (T1) to a supply voltage terminal (IN), a capacitive element (C) in which the a first terminal is connected to a second terminal of the inductive element (L) and a second terminal to the ground terminal (GND), and an output terminal (OUT) for outputting an output voltage, which terminal is connected to the first terminal of the capacitive element (C), characterized in that a second switch (T4) is arranged in parallel to the capacitive element (C).

2. Switching regulator according to claim 1, characterized in that a diode (D1) is arranged with reverse bias in terms of the supply voltage in parallel to the series circuit of the inductive and capacitive elements (L, C).

3. Switching regulator according to claim 2, characterized by a third switch (T2) which is arranged in series with the first diode (D1) and in parallel to the series circuit of the inductive and capacitive elements (L, C).

4. Switching regulator according to one of the foregoing claims, characterized by a control circuit (1) which opens and closes in phase the first and second switches (T1, T4).

5. Switching regulator according to claim 4, characterized in that the control circuit (1) opens and closes the first and second switches (T1, T4) in phase to generate an output voltage in an interval on both sides of the supply voltage, and opens and closes the second switch (T4) while keeping the first switch (T1) open to generate an output voltage above this interval.

6. Switching regulator according to claims 4 or 5, characterized in that the control circuit (1) opens and closes the first and second switches (T1, T4) in phase to generate an output voltage in an interval on both sides of the supply voltage, and opens and closes the first switch (T1) while keeping the second switch (T4) closed to generate an output voltage below this interval.

7. Switching regulator according to one of the foregoing claims, characterized by a fourth switch (T5) which interrupts the connection between the second terminal of the inductive element (L) and the first terminal of the capacitive element (C), and by a second diode (D3) which connects the first terminals of the inductive and capacitive elements (L, C) with reverse bias in terms of the supply voltage (Vcc).

8. Switching regulator according to claim 7, characterized by a fifth switch (T3) arranged in series with the second diode (D3) between the first terminals of the inductive and capacitive elements (L, C).

9. Switching regulator according to claim 8, characterized by a control circuit which keeps the fourth switch (T5) open and the fifth switch (T4) closed in order to generate an output voltage of the same sign as the supply voltage, and which keeps the fourth switch (T5) closed and the fifth switch (T4) open in order to generate an output voltage of the opposite sign relative to the supply voltage.

10. Switching regulator according to one of claims 4, 5, 6, or 9, characterized in that the control circuit (1) is a digital signal processor.

11. Amplifier, especially for an audio signal, characterized in that said amplifier has a switching regulator (2) according to one of the foregoing claims, and that the output signal of the amplifier is derived from the output voltage of the switching regulator (2).

12. Amplifier according to claim 11, characterized in that said amplifier has a comparator to compare the output voltage of the switching regulator (2) with a voltage specified as a function of the amplifier input signal.

13. Amplifier according to claims 11 or 12, characterized in that a low-pass filter (5) is located between the output terminal of the switching regulator (2) and the output of the amplifier.
